(19) United States
(12) Patent Application Publication
(10) Pub. No.: US 2007/0027714 A1
(43) Pub. Date: Feb. 1, 2007

(54) Automated healthcare services system

(76) Inventor: Christopher Fenno, Solana Beach, CA (US)

Correspondence Address: FISH & RICHARDSON, PC, P.O. BOX 1022, MINNEAPOLIS, MN, 55440-1022, US

(21) Appl. No.: 11/386,219

(22) Filed: Mar. 21, 2006

Related U.S. Application Data
(60) Provisional application No. 60/664,150, filed on Mar. 21, 2005.

(51) Int. Cl. G06Q 10/00

(52) U.S. Cl. 705/2

(57) ABSTRACT

An automated healthcare services system and automated workflow process is disclosed. The system includes a thin client program providing user access to the system via a web browser. The system further includes a service-oriented architecture comprising a plurality of functional modules, each functional module receiving data from the thin client program and processing a workflow of a healthcare service based on the data. The system further includes a set of core services for administering operations of the service-oriented architecture.

### CROSS REFERENCE TO RELATED APPLICATIONS

The present application claims priority under 35 U.S.C. §119 to U.S. Provisional Application Ser. No. 60/664,150, filed Mar. 21, 2005, entitled AUTOMATED HEALTHCARE SERVICES SYSTEM, the disclosure of which is incorporated herein by reference.

### BACKGROUND

Conventional managed healthcare systems are comprised of a number of participants operating heterogeneous and often incompatible information systems. All of these disparate systems contribute to high overhead, burdensome costs, performance challenges, and task, service and informatics inefficiencies in the healthcare delivery process. The ultimate consumer of healthcare services, the patient, invariably suffers, as does society at large, which often must shoulder a large part of the costs and risks.

In some systems, intermediaries or brokers have inserted themselves into the process, ostensibly to help manage the healthcare services, but typically just adding layers of costs and complexity to the system. Further, the presence of these intermediaries or brokers simply confirms the present disorder within conventional managed healthcare systems, despite advances in web-based computing systems and communication architectures.

Currently, numerous steps involving multiple primary and third parties are required to process a prescription or Referral “order”, especially in managed care programs, as is required for most outpatient diagnostic and treatment services. The referral management processes required in radiology with currently prevalent third party and/or Broker PPO models clearly interferes with the service, performance, and infornatics levels—potentially detracting from managed care program effectiveness and savings, and patient treatment and recovery times. In worker's compensation systems, such service delays equate to tangible employer, payer and government expenses, including additional worker disability payments and replacement costs which are highly targeted by current reforms.

Expert opinion contends that e-health and managed care solutions are merging, and that the former will enhance, transition, and eventually subsume the latter with higher value informatics-based models. Web solutions are required for the added complex procedures, payment arrangements, charge codes, and reporting of managed care systems and referral-based outpatient treatment and diagnostic testing services. Healthcare providers and payers cannot afford to continue to manage contracts, billing, or other mutual transactions manually with a large number of parties, which is especially true of fragmented, complex and highly specialized radiology and diagnostic providers.

### SUMMARY

This document discloses an automated healthcare services system and workflow method. The system includes a self-managed medical/healthcare service provider network and integrated call center application to deliver on-demand, real-time, Internet-based solutions. The system removes unnecessary middlemen and obsolete technologies from contracting, ordering, authorization, referral, appointment, reporting, billing and other related processes in managed care scenarios, replacing them with automated, intelligent systems that improve performance and better support Patient treatment and cost containment programs.

The system integrates specialty healthcare provider operations, managed care, practice management applications, call center functionality, and provider and payer extranets. For the specialty healthcare provider operations, the system automates strategic marketing, contracting, and provider and client services. For the managed care functions, the system provides diagnostic (Dx) services management, web-centric preferred provider networks (PPO's), and process and exchange automation, such as referral, authorization, provider selection, and utilization management.

The practice management applications automate routine tasks with third parties, and integrates analysis on eligibility, contracting, scheduling, reporting, the computerized patient record (CPR), claims, benefits, financial transactions and payments. The web-based call center functions include self-managed, web-powered call center services and task-automation applications. The provider and payer extranets integrate provider and payer with their managed care organization (MCO), networks and subscriber programs. The system also provides a platform for application development and integration.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a functional block diagram of a client/server system architecture.

FIG. 2 illustrates the application framework.

FIG. 3 illustrates a system workflow according to one embodiment.

Like reference symbols in the various drawings indicate like elements.

### DETAILED DESCRIPTION

This document describes systems and methods to capture medical diagnostic, radiology, and other referral-based, outpatient provider e-healthcare business by displacing the inefficient, non-preferred, and scrutinized models currently serving payer cost containment programs in many specialty healthcare markets, particularly worker's compensation. These systems and methods leverage Web platform solutions and new business models, to transition, evolve, and eventually subsume the managed care, practice, and information models serving these provider and healthcare markets.

Via an integrated Web-based call center (BPO/PPO) and application service provider (ASP) platform, these systems and methods provide new preferred pricing, service, and informatics models that aggregate and standardize radiology, diagnostic (Dx), treating provider, and client subscriptions and high volume transactions—as required by payers and in managed care programs. These systems and methods aggregate participating Providers and Payer clients with a mutually beneficial offering of connected Web functionality (ASP), provider networks (PPOs), new preferred pricing models, and informatics services as a complete solution providing major value enhancements in our target high volume markets.

The far-reaching problem of managed care and third party disruption and compromised value via the industry's current use of people and old technologies is confronted, where advanced Web solutions can provide immediate and long term improvements. Faster, better Web-based delivery of critical diagnostic and outpatient treatment provider services and information in referral-based managed care systems is facilitated, especially for the administrators who depend on their outcomes and integration with physicians and trading partners. Web solutions in radiology and diagnostics will immediately enhance and/or replace the currently disruptive solutions and prevalent Broker PPO models of risk-free arbitrage.

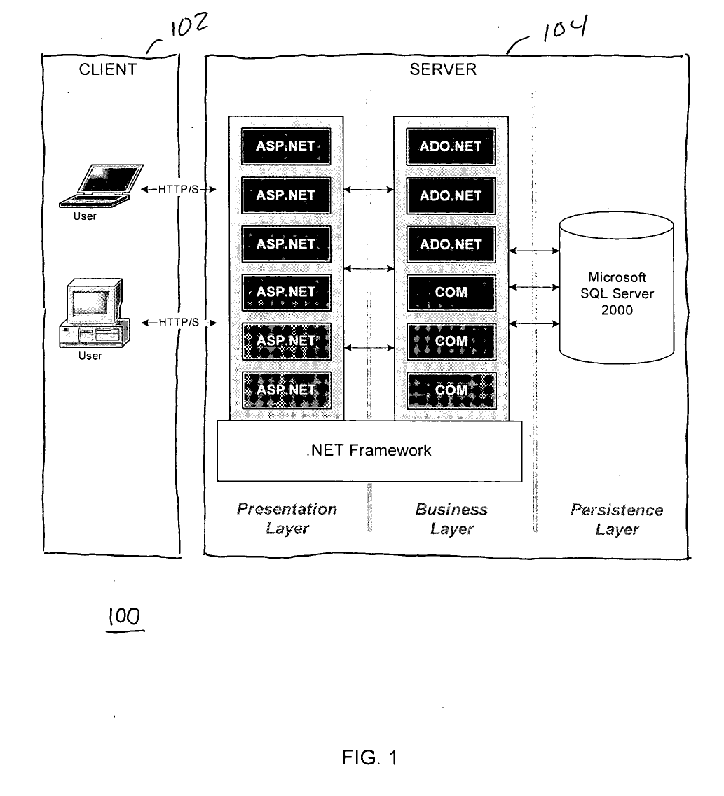

FIG. 1 illustrates a preferred exemplary embodiment of a healthcare services provider system 100. In one implementation, the system 100 includes an application built on the NET application platform, using ASP.NET for the presentation layer, ADO.NET, VB.NET for the business layer, and Microsoft SQL Server 2000 for the persistence layer. Other platforms, presentation layers, business layers and persistence layers can be suitably used.

The system is implemented as a client/server architecture, where application processing is split between two or more platform locations, with one of the platforms close to the user (the “client” 102) and the other close to the data (the “server” 104). Communication between the client and server can be based on the HTTP and/or HTTPS protocols. These protocols are widely supported and allows the communication to tunnel through many network perimeters, such as firewalls. Other protocols, such as wireless and other telephony communication protrocols, can be suitably used.

User requests, which are part of the online functionality, are absorbed by the application component closest to the client 102 (which supports the user via a friendly interface, generally a graphical user interface (GUI)) and sent to the remote application component for processing. The server 104 provides services requested by the client. The client 102 initiates the dialog, while the server passively waits for requests.

Processing is distributed to the location where it is best handled. For example: by providing the GUI at the same location as the user (on their desktop), the system 100 speeds up the user's response time, while at the same time the “heavy lifting” of the application, such as business logic and data processing, can be performed on a larger server computer. Distribution and maintenance of the application is simplified since code is maintained only in one place, and the server 104 supports all of the clients 102. Thus, the application is highly scalable, and the server 104 can be located anywhere.

The application in a client/server architecture may have more than two component locations (or ‘tiers’), and can be made up of reusable pieces. For example, the original client request may be partially processed by an intermediate server, that in turn sends further requests to another server (perhaps for data, for example). The client 102 and server 104 code interact via any of a number of message protocols, which can be composed of any language or facilities.

In an embodiment, the system is implemented as a multi-tiered design. The multi-tiered design is a form of client/server architecture having a number well-defined and separate processes, although in alternative embodiments the system may be implemented as a one-tiered system. In an exemplary preferred embodiment, the system 100 is implemented as a three tiered system. Tier 1 is the user interface and runs on the user's computer called the client 102. Tier 2 is the middle tier and contains functional modules that actually process the data. The middle tier typically resides on the server 104 and is called the application server. Tier 3 is the database access level and is the tier that interfaces directly with the database management system (DBMS) that stores data required by the middle tier. This tier typically runs on a second server 104 and called the database server. Three-tier design provides modularity that makes it easier to modify or replace one tier without affecting the other tiers. Separating the application functions from the database functions makes it easier to implement load balancing.

In more detail, Tier 1 includes the GUI, which is designed to be visual, intuitive and easy-to-use. Tier 1 supports all man-machine interface, and supports user navigation around the application and system. In some embodiments, the Tier 1 incorporates such tools as ASP.NET, XHTML, DOM, JavaScript, and CSS. Tier 2 includes the presentation and business logic for the application. In some embodiments, the Tier 2 incorporates such tools as IIS, VB.NET, and Visible Developer. Tier 3 provides for data, physics checks, data rules, and an audit trail. Tier 3 uses such tools as Visible Developer, and is highly reusable across the system 100 and its application components.

In some preferred embodiment, the system 100 includes a thin-client type of client 102, which is a type of client/server application in which the only application code executed at the client location is run inside a web browser, such as Internet Explorer or Netscape Navigator. This ensures that any user platform that can run a browser can support the application.

The system 100 can be integrated with numerous external systems and applications, such as state (i.e. State of California) applications, insurance provider applications, healthcare provider applications, employer and union applications, as well as other third party partner applications. The system utilizes a service bus architecture to provide a robust and flexible framework to support the data exchange for these interfaces. The service bus architecture is based on a messaging backbone, or “bus”, that allows data to be passed to and from the system and other applications. The messaging backbone can be implemented in any one of a number of known message exchange platforms or technology. Messages exist in the service bus in an XML format, but the architecture is very flexible and allows a variety of possible connectors to access the data (e.g. one system may pass flat files over FTP and another system may use SOAP). The service bus architecture employs a security policy that ensures that all interfaces have an authentication process for proper identification, and that each message handling process supports an authorization process.

In one exemplary embodiment, the system includes a simple point-to-point messaging system, whereby data is transferred from a sending application directly to one or more recipient applications. The messaging protocol is robust in that the delivery of the data is guaranteed. The messaging backbone will hold on to the delivery until its receipt and/or consumption has been confirmed by the recipient application. This is the mechanism that can also be used when data is being sent from an external system back to the system 100.

In another exemplary embodiment, the system 100 includes a publish-and-subscribe system. In this system, data is published to the backbone under a specific topic. Other applications may subscribe to that topic (provided they have authorization) and will receive a copy of that data. The publishing application does not need to be configured to be aware of the subscriber. Subscribers can also set up message queues for a topic to guarantee the delivery of the data, as with the point-to-point method. This mechanism will be used for data that needs to be broadcast to the network to any number of listening applications.

Each client represents any user, and includes the patients, treating physicians, qualified medical examiners, specialist physicians, payer, employer, third party administrator, claims adjuster and/or case manager. Additional users include other hospital staff, therapists, the patient family members, attorneys, and government agencies.

The patient represents the user of the system that is being treated for an injury or illness. A case will be setup for the user that tracks their progress through the system and stores all records relating to their physician visits. Treating physicians, and in the case of occupational and/or workplace injuries Qualified Medical Examiners (QME), will often be the first physician to see the patient following an injury. It is this physician that would order a referral for a specialist, such as a radiologist. The treating and/or QME physician and their office will need to access the system to perform the referral and can also use the system for scheduling and record tracking services.

The specialist physician is the physician that provides the specialized service for the patient, such as performing X-rays. The specialist and their office will access the system for scheduling purposes, performing intake, discharge, submitting the professional report and coordinating payment. The payer is any entity that will pay for the specialist services. The payer could be an insurance company, an employer, a third party administrator, or even the patient (self-pay or co-pay).

In the case where the patient was injured on the job, the patient's employer, third party administrator or union may access the system as well. Often times the employer will operate in the system instead of the patient. The insurance claims adjuster will be a user of the system as well to process claims that are handled by the insurance company. The case manager is a user affiliated with the company that is charged with the responsibility to make sure the patient is treated properly. Often times the case manager will have a medical background, such as a registered nurse (RN).

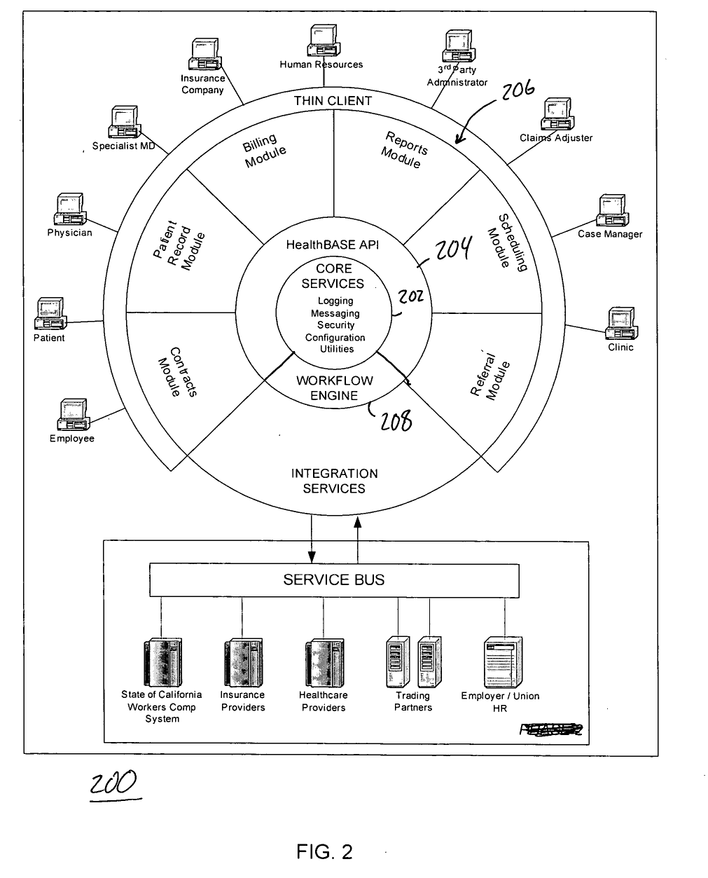

An overview of an application framework 200 is shown in FIG. 2. The application framework 200 includes core services 202. The core services 202 include the underlying application services for logging, messaging, user authentication (login), authorization (permission checking), configuration management and other underlying utilities. The core services 202 also provide access to user, group, location and clinic information.

The system application programming interface (API) 204 includes code that interfaces between the core services 202 and various functional modules 206. Each functional module 206 will have a public interface that other components in the system can access. A central component of the API 204 is a workflow engine 208. The workflow engine 208 is responsible for tracking the patient through the end-to-end process. It allows the workflow processes and task assignments to be configurable through a web interface.

Integration with external systems is handled through a service-oriented architecture. This architecture and the interfaces it will support is described in further detail below. Each application module will now be described in further detail.

Contracts Module
Sub-Modules: Provider Profile
   Payer Profile (including Payer Rules Engine)
   Contract Template

The contracts module manages the information related to the provider profile and the payer profile/payer rules-engine and the relationship (contract) between these two entities. This relationship determines the terms and conditions of their interactions, the service criteria and the fee schedule. A provider can have a contracting template. This template can be used to simplify the process of adding and configuring new contracts with payers.

The Patient Record Module
Sub-Modules: The Patient Profile
   Physician Report
   The Patient History
   First Report of Injury (FROI) Report

The Patient Record Module manages all of the data associated with the patient and includes the master patient index file. This includes the personal, administrative and clerical information of the patient, as well as information relating to office visits and all reports (FROI, Physician Report, etc) that are associated with the client. This includes any image and media attachments related to reports and diagnostics.

Billing Module
Sub-Modules: Appointment Summary
   Superbill
   Auto-Coding
   Auto-Adjudication
   Re-Pricing
   Claims Processing
   Co-Payment
   Remittance

The billing module provides the functionality relating to handling business transactions for services rendered. Following an office visit with a specialist provider, all of the billing information is to be calculated and submitted into the system from the provider. Based on the provider's profile configuration and contract configurations, the superbill (final billing statement that includes outputs from the sub-modules listed above) will be generated. This billing statement will show all price adjustments and discounts. The billing module also determines the patient co-pay and/or deductible. This can be derived from the provider and the payers'contract. The billing module also handles the business logic required for claims processing.

The billing module also provides the functions necessary to process any payments. In phase 1, payments will be handled through the current offline (non-system) process and an authorized user will need to record in the system that the bill has been settled. In phase 2, the system will support multiple methods of payment to automate the transaction between the provider and payer.

Reporting Module

The reporting module provides the functionality required to derive custom and ad hoc reports on the utilization of the system. This will include metrics for the number of office visits, referrals, payments, gross charges, savings, etc. The reporting module can also generate professional reports similar to those discussed above with respect to the patient record module, and as such can include reference images or other media, utilization and management reports, etc.

Scheduling Module
Sub-Modules: Calendar Scheduling
   Intake
   Discharge

The scheduling module provides the functionality required for an appointment to be setup with a physician's office (either a QME or specialist). The scheduling module includes functionality that manages the clinic schedules and appointments, and functionality for performing intake and discharge processing with the patients.

Referral Module
Sub-Modules: Order Entry
   Eligibility
   Authorization and Pre-Certification
   Provider Selection

The referral module handles all functions relating to the ordering of a visit with a specialist provider, including but not limited to: the service order, the determination of the patient eligibility; and the payer authorization and pre-certification; selection of the provider.

Once the treating and/or QME physician makes the determination that a specialist provider is needed for additional diagnostics (such as a radiologist), each of these steps are executed to complete the referral. For more detailed information regarding the process involved in each step, refer to the Patient Processing Workflow section below.

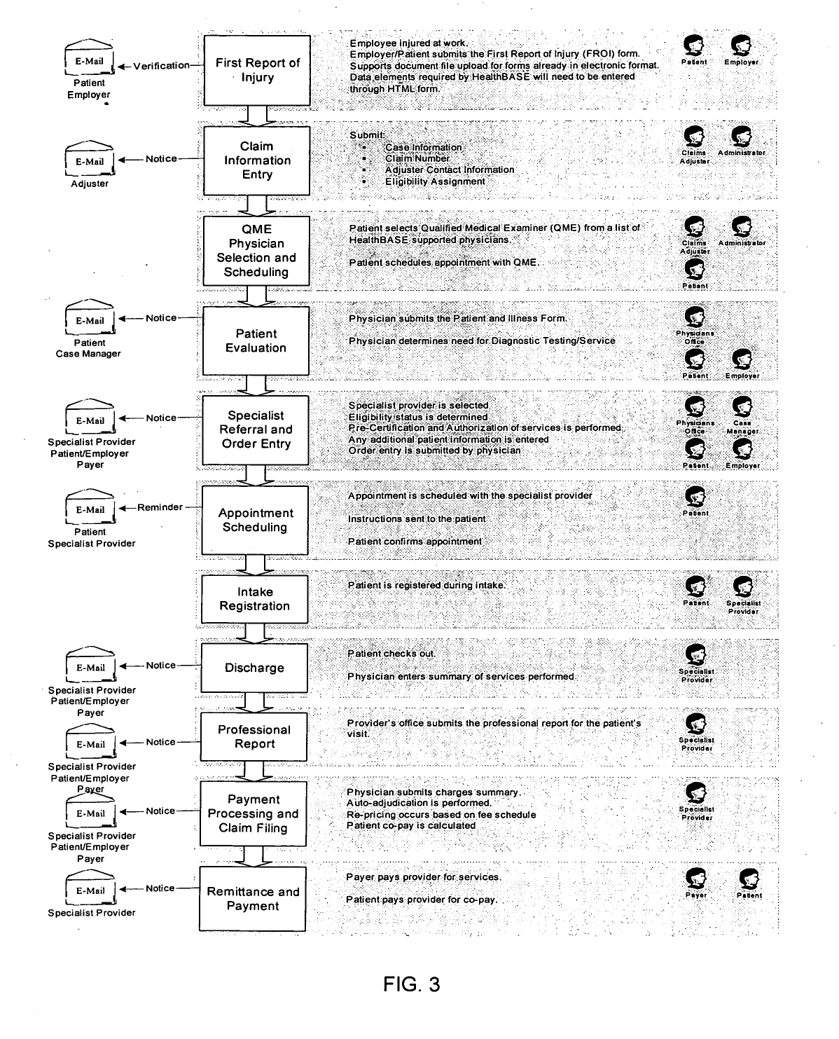

FIG. 3 is a flow diagram of the workflows of the system. In an illustrative example, the workflow describes a healthcare services process from the time an injury or condition is reported to the final processing and payment for treating the injury or condition. Each of the workflow processes and the modules used by each process are described in more detail below with respect to exemplary embodiments.

First Report of Injury
Modules: The Patient Record Module

When an employee is injured on the job, a First Report of Injury (FROI) form is processed. This form is also known as an “Initial Report of Injury” (IROI) in some jurisdictions, however, any initial report of an injury and/or condition of a patient who will utilize this system is acceptable. Normally, both the employer and the patient complete and file the occupational injury claim with the patient's employer's Human Resources (HR) department and the state worker's compensation agency.

A dynamic database is created around each FROI that enters the system. The system links with any dynamic or static FROI applications or fields, including from document imaging and fax. The HR/employer, physician office, and/or patient users may need to create FROI using the application, if FROI has not yet been completed. For an injury within California, for example, the system interfaces to the CA state workers compensation EDI system, or to a third party vendor providing same interface and/or transaction service. The FROI template with EDI interface can be obtained through direct connectivity to the State of CA—and/or from third party vendors. Web (non-EDI) interfaces to a state system can also be made available.

Initial input may be by paper form—in which case document scanning and fax, and/or word attachment to e-mail could be outputs to the system in the application used to process an electronic FROI. The FROI can be filed with the state by the system. Initial input and output to the system could come from a third party FROI application.

The steps of the FROI workflow include: 1) The patient and employer file claim with the state and copy authorized third party payer(s) and Administrators; 2) a claims administrator is assigned to track and managed all benefits and services provided to the claimant (i.e. the patient); 3) a treating physician and/or QME is assigned to evaluate and provide initial patient injury diagnosis; and 4) a provider assignment triggers the system application requirement. The output of the FROI workflow includes a completed FROI form, followed by immediate assignment of: a claims administrator and/or adjuster; a treating physician, and/or QME, such as an occupational injury specialist.

Numerous payers may require output from a patient's FROI or FROI program application. The FROI output is the initial and primary data element and source used to populate the application data fields. The FROI will populate a system “Master Patient Index File” that will follow the patient throughout the system user groups and locations. The system will enable automated Provider Assignment tools, including: provider lookup, selection, referral, appointment scheduling, and other applications to streamline the initial QME provider assignment, as well as subsequent diagnostic, radiology and treatment provider referrals.

Claim Information Entry
Modules: Contract Module
   The Patient Record Module

Upon receipt of notification that a FROI has been filed, the employer's payer/insurance company and/or third party administrator (TPA) assigns a claims adjuster and claim/case number, along with establishing patient eligibility to receive services under the payer's benefit and medical management programs. A provider inquiry of the patient eligibility status is then generated and sent (via form, e-mail, messaging, etc.).

QME Physician Selection and Scheduling
Modules: Scheduling Module
   The Patient Record Module

The passage of California law SB 899 changed the process for choosing QMEs. Employees seeking workers'compensations benefits who are not represented by an attorney must now select a QME from a panel of three (3) medical evaluators provided by the DWC medical unit to resolve claims disputes on both accepted and denied cases. After Jan. 1, 2005, represented employees who do not utilize an agreed medical examiner must also use QME panels.

In addition to the new requirement to utilize QME panels, there are now time limits to make the QME request, select a medical evaluator from the panel, and make an appointment. The following time limits apply to unrepresented employees as of Apr. 19, 2004:

When the claims administrator requires an employee to see a QME, the employee has 10 days to submit a “Request for Qualified Medical Examiner” or similar form to the DWC Medical Unit. If the employee does not submit the request within 10 days after receipt from the claims administrator, the claims administrator has the right to: (1) submit the request directly without further involving the employee; and (2) select the medical specialty of the QME panel.

When the DWC Medical Unit issues a panel, a copy will be sent to both the employee and the claims administrator. The employee has 10 days from the date the panel issues to: (1) select a QME; (2) make an appointment; and (3) notify the claims administrator of the selection and the date of his or her appointment. If the employee fails to timely notify the claims administrator, the claims administrator has the right to select the QME and to make the appointment.

These new requirements are now in effect, but DWC will develop regulations to help clarify the process. The system includes web-based processes and exchange applications that simplify and automate the tasks required in selecting QME's under CA law (and potentially the laws of other states, as well).

The patient selects from the system database of QME providers, and/or from the three (3) or more QME provider (medical evaluator) options provided to the patient by the state division of worker's compensation, such as the California Division of Worker's Compensation (DWC) Medical Unit. The patient then enters provider selection criteria in the application and is automatically matched with optimal QME provider choices based on those criteria and any claims administrator and/or DWC criteria.

The Patient Evaluation
Modules: The Patient Record Module

Following initial physician (MD) evaluation of the patient's workplace injury or condition, the MD's preliminary diagnosis findings are matched with targeted clinical reference guidelines and/or treatment or diagnostic imaging protocol from medical associations and clinical resources, state and federal agencies, and/or third party vendors. The output of this step in the process is the diagnosis summary. The diagnosis summary automatically links to Treatment and Care Management applications.

Specialist Referral and Order Entry
Modules: Referral Module
   The Patient Record Module

Diagnostic testing requirements are determined at this step of the workflow. Following initial physician (MD) evaluation of the patient's workplace injury, the MD's preliminary diagnosis findings and further diagnostic testing objectives (i.e., the diagnostic findings sought) are matched with selected clinical references and/or diagnostic imaging protocol, as according to guidelines from medical associations, government agencies, industry groups, payer organization (internally developed), and third party review companies (outsource solutions).

The next step is to determine the type and urgency of diagnostic imaging service(s) required, such as appropriate medical diagnostic and/or imaging test(s). This determination can be based on payer and/or third party rules, and the results can be output or delivered to the treating physician, the provider, the payer, the patient/employee, the employer/HR, and/or state agency.

For the referral, the physician determines Diagnostic provider testing services required and creates a prescription for it. The application determines a suitable referral process based on, at least in part, the patient (employer and/or client), the type of diagnostic service requested, and/or the payer rules for utilizing same services, under the identified managed care program physician.

To determine eligibility status, the referring physician office, or the referral provider, and/or another referral source (the patient, the employer, etc.) must pre-determine the patient's eligibility under third party healthcare coverage to receive paid benefits for the selected specialist referral provider services. At the time of patient's receipt of the referral order (at the physician appointment), the physician office may determine the eligibility for the patient to receive those prescribed referral services from the provider. The physician office will contact payer—usually via EDI, Fax, mail and/or phone call. Any additional information for the patient prior to appointment scheduling and intake is also submitted during this step of the process. The system includes automation capabilities for these eligibility, scheduling and intake functions.

Per payer rules and the selected referral service(s) (i.e. type of testing and/or treatment requested)—the referral may require pre-authorization from payer and/or third party review. The physician office usually contacts payer at the time patient receives a prescription from physician. Ideally, authorization outcome is known and the referral order completed prior to the patient departing from the physician office. Often, however, the patient leaves the physician office and authorization is obtained later, following contact and information exchange per the authorization process.

The system includes internal business logic for making determinations of whether a referral is authorized. If this determination cannot be made based on this internal logic, then an authorized user, such as a case manager, will need to make that determination and submit it through an online web-based form. Alternatively, the system will interface with authorization systems of each payer and/or client to help gather information and process the authorization automatically.

The patient, and/or with assistance from referral processor (physician Office staff; case manager, etc.), enters criteria for selecting the optimal provider based on referral order information from physician prescription, plus patient requirements for services, locations, appointment availability, payment terms, etc. The Provider Selection application automatically and systematically matches selection criteria against database of Payer Rules and participating PPO network providers. The Provider Selection Application uses geo-coding reference (versus zip code matching) to create optimal provider matches—listed according to closest proximity and greatest match. Selected providers will link to provider profiles and also to provider appointment schedules (provider calendars). The physician and referral processor provide referral delivery instructions and information to complete all referral delivery information to authorized parties, per payer rules.

Appointment Scheduling
Modules: Scheduling Module
   The Patient Record Module

After selecting the provider, the patient and/or referral processor are linked to the Provider Appointment Scheduling application and a Provider Calendar application. Periodically (i.e., in each a.m.) and at any time when requiring updates, the providers (i.e., radiology sites) will show available appointment times on the Provider Calendar application, which automatically links and updates with all Appointment Scheduling and Provider Profile applications.

The patients and referral processors can access real time, 24/7 Provider Appointment Scheduling applications whereby either 1) provider utilizes and continuously updates their Appointment Calendar application (as they update other/primary practice Appointment systems), and/or 2) Scheduling applications are interfaced to primary provider practice and/or appointment scheduling information technology (IT) systems. The user selects the optimal, available appointment time and date. If the patient has selected the time, they can instantly confirm—and the final, confirmed appointment information and other referral order data elements are copied, as applicable, to any/all authorized parties. If the referral processor sets appointment time, patient will need to confirm final appointment information before the referral is complete and all authorized parties are notified.

After the referral order is processed and the appointment is scheduled, and then confirmed by the patient, the patient will instantly be linked to and receive instructions at contact locations. These instructions are communicated in preparation for the specific type of service(s), such as testing and/or treatment, being provided to patient at the appointment. The application will automatically cross reference the appointment service type with clinical guidelines (i.e., instructions and preparations) and also the individual patient history and conditions, as provided, to create an optimal appointment instruction applications. Instructions are re-delivered to the patient along with subsequent Appointment Reminders.

The referral order and appointment summary (as scheduled) are delivered to the patient, who then must confirm the information. In the event appointment was scheduled by a referral processor, the patient needs to confirm the appointment as scheduled—and will then receive the appointment instructions. The patient will also receive periodic reminders of the appointment scheduled prior to the appointment time/date.

Intake Registration
Modules: Scheduling Module
   Patient Record Module

The Patient checks in at referral appointment with provider office. The patient confirms and, if necessary updates, any/all patient, referral and other information provided via the referral order, including compliance with preparation instructions.

Discharge
Modules: Scheduling Module
   Patient Record Module

Patient checks out at conclusion of provider appointment. Provider summarizes all services delivered via the Summary application. In the case of radiology providers, technologists complete a service summary form (check list) and/or summary application screen—or the provider office staff inputs a form completed by the technologist into the service summary application. The summary application data is automatically cross referenced with payer contract rates and/or terms and the provider profile to create an appointment discharge summary that summarizes all services and likely charges from the visit.

Professional Report
Modules: Scheduling Module
   Patient Record Module

Following completion of diagnostics or other testing, images and other media resulting from the testing procedure are delivered to the attending radiologist or other specialist physician assigned to read this exam. The radiologist or other specialist receives, reads, and interprets the images—and typically dictates his/her findings by oral report. Also typically a staff member of provider office receives the dictated message and transcribes the report into a document—preferably MS Word or any other standard report application. The transcribed report is delivered back to the radiologist who interpreted the study, and he/she reviews it for accuracy and editing, then signs the final report and returns it to office staff for delivery to referring physician and authorized client(s).

A professional report also is required with all billing claims prior to payer processing for payment. The professional report provides the key data element and outcomes resulting from the referral event. Thus, it is attached to all post-testing/treatment services administrative and clinical support transactions. Reports are currently delivered primarily via auto-fax, mail and physical delivery along with the referenced radiology films. Professional Reports are also received increasingly more by e-mail and Web applications, and their attachment to EDI and Web-based billing transactions will help optimize payment turnaround times and values.

The system captures the radiology report electronically to enable radiologists and other interpreting physicians to receive, review and execute electronic signature and authentication applications in order to finalize the reporting process and allow for electronic delivery and simplified integration with other data elements and resources. This will include images and multi-media files, as well as all other referral elements described in this document, which will collectively allow for the creation of a patient computer record module for the medical services that the system supports.

Payment Processing and Claim Filing
Modules: Billing Module

Following generation of the discharge summary, an instant itemization and calculation of services provided at the appointment can be made via cross-reference to the payer profile and contract information (per the payer profile—payment rates and terms, allowances, adjustments, discounts, etc.). This process is called the claim “Auto-Adjudication”. Ideally, the professional report will be auto-analyzed and cross-referenced for accuracy and consistency of the medical services delivered, per what is stated in the professional report and acknowledged by radiologist, and then compared to the charges created from the discharge summary. Once this automated cross-reference of billing charges and services provided via professional report is processed—a final billing statement can be created. The result is the automated summary of service charges (or “Charge Summary”).

The claim is adjudicated to meet payer guidelines for medical necessity and claims coding procedures; cross reference with other key data elements, industry standards and other references, in order to match with professional report according to payer contract and rules. The system allows that, for provider and/or provider office, automated billing and charge adjustments are made to the charge summary per the stated rules, policies and procedures, and allowances of the referenced payer (or “payer rules”). These are automatically applied to the charge and billing summaries, along with “re-pricing” to realize the superbill.

The system provides automated bill/claim re-pricing for the provider and/or provider office, which is made to the charge summary per the stated contract pricing and terms of the referenced payer (payer rules). These are automatically applied to the charge and billing summaries, along with “claim auto-adjudication” to realize the superbill. The system also ensures that resulting billing claims from the auto-adjudication and re-priced charge summary are processed and delivered to the payer and/or all authorized agents and users—per the stated rules, policies and procedures of the referenced payer (payer rules). The required components of the autoclaim, and/or the entire superbill, is delivered to the payer—as designated per the payer rules.

Co-payment processing is performed prior to final patient appointment discharge (i.e. “check out”) at the provider facility, in which the final autoclaim and payer amount are cross referenced with patient payment responsibility per eligibility reporting and policies—under healthcare plan/payer rules. According to an embodiment, the eligibility reporting of patient co-payment and deductible amounts are cross referenced with the superbill (including auto-adjudicated and re-priced autoclaim). The patient co-payment responsibility is automatically calculated, and all patient out-of-pocket charges are processed, including deductible and co-payment amounts.

Remittance and Payment
Modules: Billing Module

Payment for authorized services provided to patient by provider includes a web-based interface for an authorized user to enter transaction information to settle a payment. This will be used for transactions between the provider and payer, as well as between the patient and the provider. Alternatively, the system includes electronic funds transfer (EFT) from payer to provider's designated bank account as agreed between provider and patient (see provider profile—payment types accepted; examples—credit, debit, check, cash, terms, etc.).

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other. In one embodiment, the client uses a browser application to display a web page representing a portal to a server-based application and/or data resources stored thereon.

Although a few embodiments have been described in detail above, other modifications are possible. The logic flows depicted in FIG. 3 does not require the particular order shown, or sequential order, to achieve desirable results. Other embodiments may be within the scope of the following claims.

1. An automated healthcare services system comprising:
a thin client program providing user access to the system via a web browser; and
a service-oriented architecture comprising a plurality of functional modules, each functional module receiving data from the thin client program and processing a workflow of a healthcare service based on the data; and
a set of core services for administering operations of the service-oriented architecture.

2. A system in accordance with claim 1, further comprising a set of integration services for integrating the output of each workflow with one or more healthcare service providers.

3. A system in accordance with claim 2, further comprising a service bus for connecting two or more healthcare service providers to the system.

4. A system in accordance with claim 1, wherein the plurality of functional modules includes a contracts module to manage data relating to a contractual relationship between a user and healthcare service provider.

5. A system in accordance with claim 1, wherein the plurality of functional modules includes a patient record module to manage data associated with patient information.

6. A system in accordance with claim 1, wherein the plurality of functional modules includes a billing module to manage data associated with business transactions for healthcare services rendered to a patient by a healthcare service provider.

7. A system in accordance with claim 1, wherein the plurality of functional modules includes a report module that generates reports based on the workflows of other functional modules.

8. A system in accordance with claim 1, wherein the plurality of functional modules includes a scheduling module that electronically manages appointment schedules between a patient and a healthcare service provider.

9. A system in accordance with claim 1, wherein the plurality of functional modules includes a referral module that determines a healthcare service provider for a patient based on patient eligibility, payer authorization, and selection by the healthcare service provider.

10. A system in accordance with claim 1, wherein the plurality of functional modules includes a workflow engine that manages the plurality of functional modules.

11. An automated healthcare services system comprising:
a server platform having a thin client program providing user access to the system via a web browser, the server platform further having a service-oriented architecture comprising a plurality of functional modules, each functional module receiving data from the thin client program and processing a workflow of a healthcare service based on the data;
a telecommunications interface to send and receive data via the thin client program.

12. A system in accordance with claim 11, wherein the server platform includes a NET application platform.

13. A system in accordance with claim 11, wherein the server platform includes an ASP.NET presentation layer.

14. A system in accordance with claim 11, wherein the server platform includes a VB.NET business layer.

15. A system in accordance with claim 11, wherein the server platform includes a system query language server persistence layer.

16. A system in accordance with claim 11, further comprising a relational database to store the data associated with the workflows.

17. A computer-implemented method for automated healthcare services, the method comprising:
providing a thin client program to one or more patients, the thin client program providing access to a healthcare service server platform via a web browser;
receiving data from at least one patient of the one or more patients via the think client program, the data relating to a healthcare service; and
processing the data using a selected one of a plurality of functional modules, each functional module processing a workflow of the healthcare service.

18. A method in accordance with claim 17, further comprising initiating telecommunications between the at least patient and a healthcare service provider.

19. A method in accordance with claim 18, further comprising generating a report based on a result of each functional workflow.

20. A method in accordance with claim 19, further comprising:
transmitting the report to the at least one patient and the healthcare service provider via a telecommunications channel; and
storing the report in a database.
